(19) United States
(12) Patent Application Publication
(10) Pub. No.: US 2003/0155218 A1
(43) Pub. Date: Aug. 21, 2003

(54) Rotary rocker switch

(76) Inventor: Peter Raimund Panagl, Uetikon (CH)

Correspondence Address: PEARNE & GORDON LLP, 526 SUPERIOR AVENUE EAST, SUITE 1200, CLEVELAND, OH, 44114-1484, US

(21) Appl. No.: 10/077,726

(22) Filed: Feb. 15, 2002

(51) Int. Cl. H01H 19/58

(52) U.S. Cl. 200/11 R

(57) ABSTRACT

A switch is provided with OFF and ON positions and also a Pulse On or Trigger position. The switch automatically springs back from the Pulse On or Trigger position to the ON position. The three switch positions are arrange on an essentially circular support body or switch base. The switching element or switch housing is rotatably supported on the switch base. A flat coil spring pushes the switching element or switch housing from the Pulse On or Trigger position to the ON position.

This invention relates to an electric switch with at least three switching positions as specified in the characterizing clause of claim 1, to an electric or electronic component provided with an electric switch, and to a hearing aid incorporating an electric switch.

Electric switches which, in addition to the ON and OFF position, feature at least one more switching position from which the switching element usually returns automatically to one of the aforementioned positions, have essentially been part of prior art. One example found in daily life is the start switch of an automobile, where the ignition lock is turned from its initial OFF position into the start position, from which, after the engine is started, it then moves back part of the way into the ON position in which the engine is kept running.

All prior-art switches are relatively large and their design concept does not lend itself to miniaturized i.e. microswitches for the switching of small electrical and electronic devices such as hearing aids and the like.

It is therefore the objective of this invention to introduce an electric switch which, in addition to the traditional ON and OFF positions, includes at least one more switching position and which is particularly well suited to the operation of miniature devices. There is a particular need for a switch which apart from the regular ON and OFF positions includes at least one additional ON position which, however, is preferably tapped only briefly to establish a momentary contact and from which the switch returns, preferably in automatic rocker fashion, to its initial ON position.

This objective is achieved by an electric switch with the features described especially in claim 1.

The proposed electric switch includes at least the switching positions “OFF”, “ON” and “Pulse On” or “Trigger”, with the switch automatically jumping or rocking from the Pulse On or Trigger position back to the ON position. The minimum of three switch positions are arranged on an essentially circular support body and the switching element that is rotatably mounted along the support body can be moved under the action of a flat coil spring from the Pulse On or Trigger position into the ON position.

The switch according to this invention preferably incorporates at least one largely circular support body with contact surface sections as well as a switching element which can be rotated around the central axis of the support body and which, under the action of the flat coil spring, can be pushed from the Pulse On or Trigger position into the ON position, with the assembly including the flat coil spring and a central shaft being held in place and resiliently held together by means of a Belleville-type cup spring.

The area between the support body and the switching element features an array of detents.

The cup spring and the detent array hold the switch in the ON/OFF positions. In the additional Pulse On or Trigger position where preferably no detents are provided, the aforementioned coil spring, tensioned by the movement into the ON position, retracts the switching element to the initial ON position in which the switching element will remain. The force exerted by the cup spring, in conjunction with the detent array, is stronger than that of the coil spring which is only weakly tensioned in the initial ON position, thus preventing the latter from moving the switch into the OFF position. It is thus only the cup spring that allows switching from OFF to ON and vice versa. Not until the coil spring is tensioned into the toggle position does it have enough torque (strength) to retract the switch into the ON position. In the OFF position the coil spring is not tensioned. Its one end is anchored in the fixed shaft or switch column, its other end in the rotary switching element.

The above-mentioned detent array preferably includes at least one detent for each of the ON and OFF positions but not, or to a lesser extent, for the Pulse On or Trigger position.

In a preferred design version the OFF and ON positions have three detents each, located at an angle of approximately 120° from one another between the support body and the switching element.

The switching element is preferably provided with a laterally protruding actuating unit such as a lever, and on its side facing the support body with a strip conductor or sliding contact which, when the lever is actuated, serves to make the connection between contact areas in the support body and the ON position or the Pulse On or Trigger position.

Other preferred design aspects of the electric switch are highlighted by their characterizing features in the subclaims and explained in the following description with reference to the attached drawings.

The switch according to this invention lends itself particularly well to the operation of electrical or electronic components in which the Pulse On or Trigger position can serve in particular for the triggering of a menu control system, permitting selection between different programs.

The switch according to this invention is particularly suitable for use in hearing aids.

The following examples will explain this invention in more detail, with reference to the attached drawings in which:

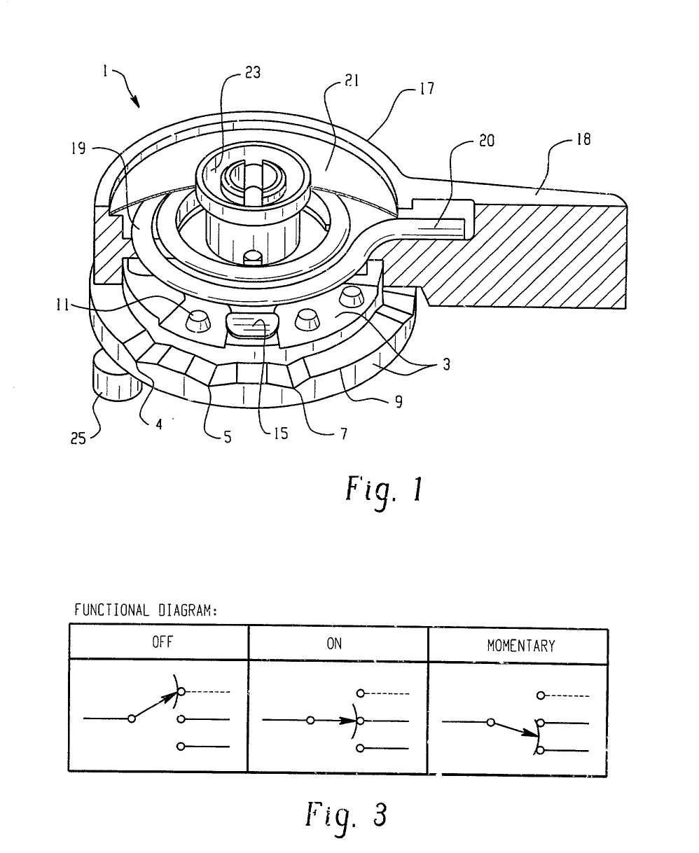

FIG. 1 is a perspective illustration of an electric switch according to this invention;

FIG. 2 is an exploded view of the switch per FIG. 1;

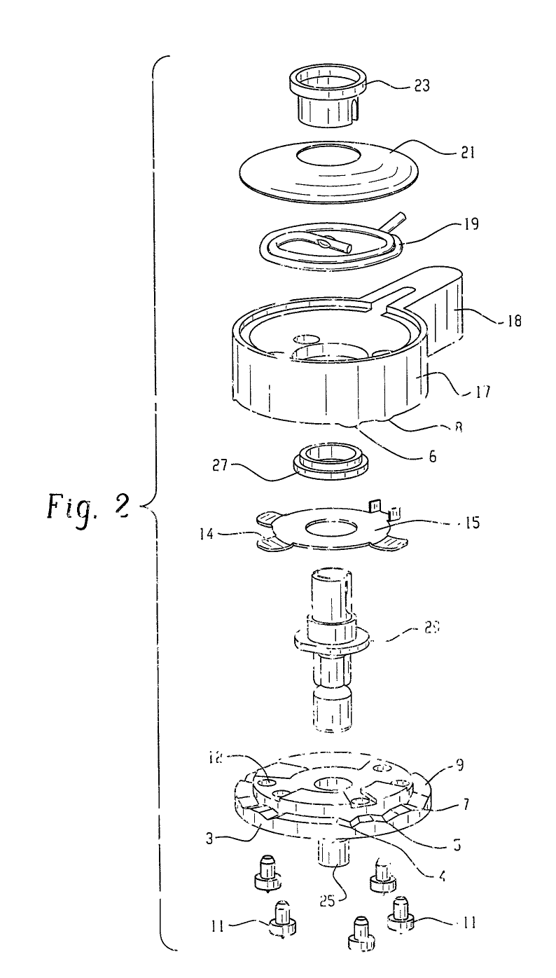

FIG. 3 schematically depicts the various switching positions of the switch per FIG. 1;

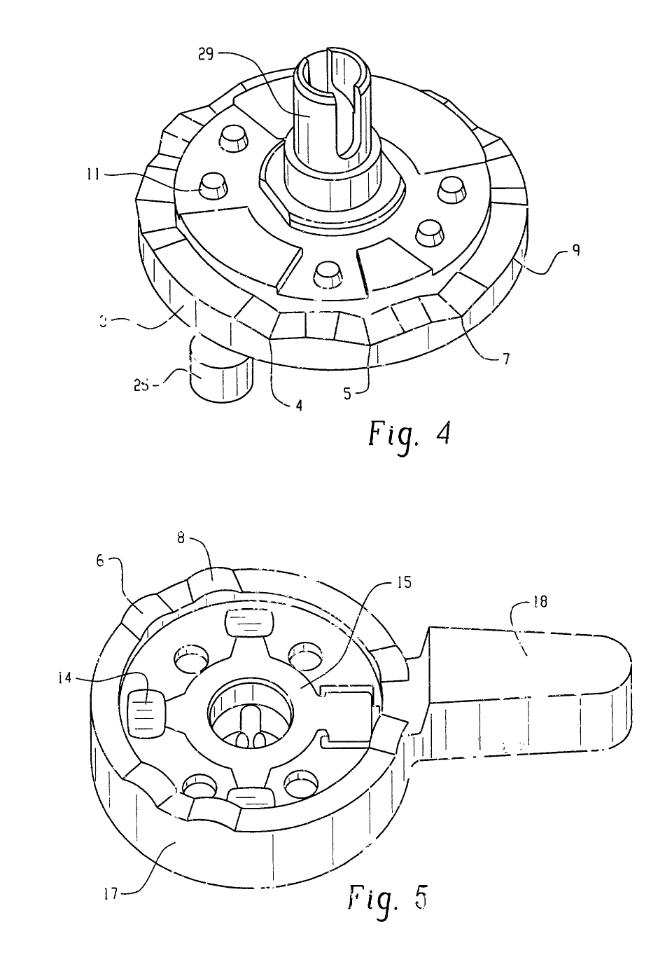

FIG. 4 is a perspective top view of a support body of the switch per FIG. 1;

FIG. 5 is a perspective view of the side of a switching element facing the support body;

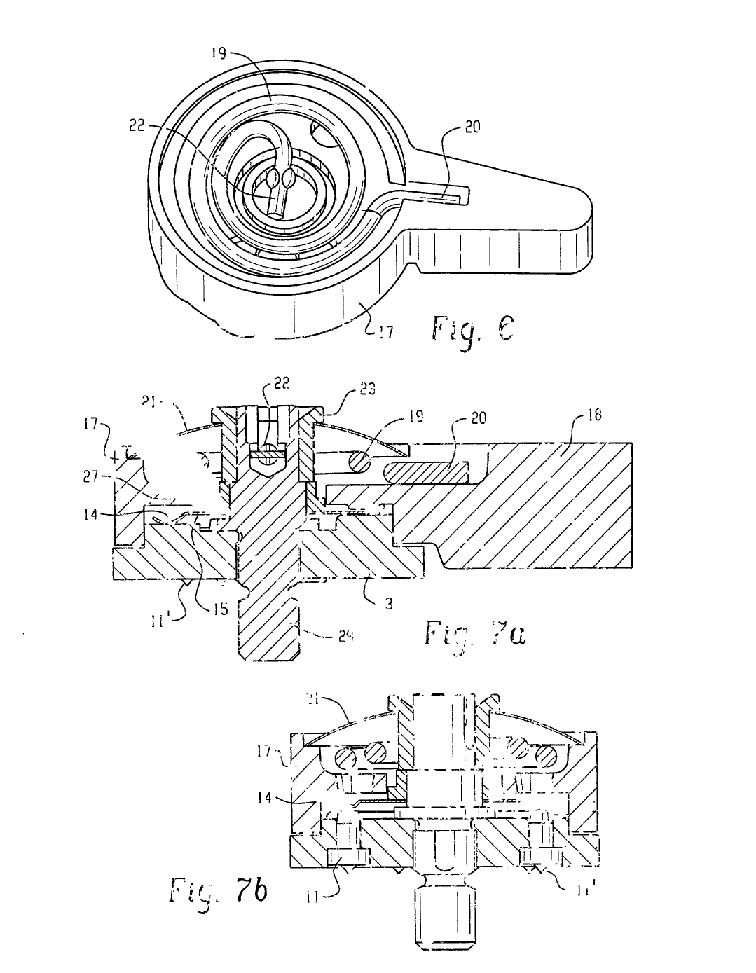

FIG. 6 shows the switching element per FIG. 5 except as viewed from the opposite side; and

FIGS. 7a and 7b are cross-section views of the switch per FIG. 1.

FIG. 1 is a schematic, perspective view of a switch 1 according to this invention, with the front cover removed to show the internal components of the switch.

Arranged on a switch base or support body 3 are the three switching positions OFF=5, ON=7, and Pulse On or Trigger=9. The two ON and OFF positions are located in corresponding notches, whereas there is no notch in the trigger position 9.

Located away from the perimeter of the switch base are contact surface sections 11 in the form of contact pins embedded in the switch base i.e. support body.

Connected to the switch base via a central fulcrum pin is a switch housing, i.e. a switching element 17 equipped with a lever 18 by which the switch is actuated. Rigidly connected at one end to an axial column is a flat coil spring 19 whose other end is connected to the switch housing i.e. to the lever unit 18. A Belleville-type cup spring 21 which by means of a retaining cap 23 on its upper end is connected to the axial column, resiliently holds the switch assembly together.

FIG. 2 is an exploded view of the switch per FIG. 1, allowing the individual components of the switch to be more clearly illustrated. Distinctly recognizable is the array of detents between the switch housing 17 and the switch base 3, showing cams 6 and 8 which protrude from the switch housing and engage in corresponding notches 4, 5 and 7 in the switch base 3. In the OFF position the cams 6 and 8 engage in notches 4 and 5, in the ON position they engage in notches 5 and 7. These positions will be discussed further in the functional description that follows.

The contact pins 11 are embedded in corresponding perforations 12 in the switch base 3, in such fashion that their upper contact ends project from the switch base. This allows the strip conductor or contact element 15 to establish a connection with the contact sections 14 in the various switch positions.

Also recognizable in FIG. 2 is the central, axial column 29 which is rigidly connected to the switch base 3 and the retaining cap 23 and around which the switch housing 17 with the lever-type actuating unit 18 can be rotated.

The following is a functional description of the switch according to this invention, with the drawing in FIG. 3 serving as a visual reference in terms of the switch positions. In the starting i.e. OFF position the two cams 6 and 8 are seated in the notches 4 and 5. In that position there is no contact made between the contact-surface sections 14 of the contact spring 15 and the contact pins 11.

When the switch housing 17 is turned by means of the lever 18, the design of the cup spring 21 allows the two cams 6 and 8 to move into the two notches 5 and 7. That movement slightly tensions the flat coil spring 19, but not enough to cause the switch to be pushed back into the OFF position. As the switch housing 17 is turned, the contact spring 15 moves with it and its contact sections 14 now establish a connection between the contact pins 11 which represent the ON position.

When by means of the lever 18 the switch housing 17 is turned further, the two cams 6 and 8 are pushed out of the notches 5 and 7 and the coil spring 19 is tensioned incrementally. As soon as the cam 8 reaches point 9 in the switch base 3, the contact sections 14 of the contact spring 15 interconnect the contact pins 11 that represent the Pulse On or Trigger position in which the pulse generated serves for instance to access a menu selector. This may be an especially practical capability for hearing aids where it is desirable to select from among different programs, such as volume, focussed listening or wide-area listening, or hearing with and without ambient noise. As soon as the desired program has been selected, the lever 18 is released and the tension of the coil spring 19 causes the switch housing 17 to jump back into the ON position.

The subsequent FIGS. 4 to 6 are perspective, enlarged views of the switch base or support body 3 and of the switch housing or switching element 17.

FIG. 4 illustrates the switch base 3 and clearly shows how three detents, in the form of notches 4, 5 and 7, are located at a distance of 120° from one another. This configuration is to ensure that the switch housing or switching element 17 which is mounted above it so as to be rotatable around the central axial column 29 will not be skewed relative to the support base 3. This is important since it will ensure that in all cases the contact spring 15 will establish a reliable connection between the contact pins 11 in the ON and Pulse ON or Trigger positions.

As is evident from FIG. 5, the switch housing or switching element 17 is provided with three corresponding catches with the protruding cams 6 and 8. FIG. 5 shows the switch housing 17 on the side that faces the switch base 3 and which features the contact spring 15 with the contact sections 14.

FIG. 6, on the other hand, shows the switch housing 17 on the opposite side on which the flat coil spring is mounted. The two ends 20 and 22 of the coil spring 19 are clearly visible, with one end, 22, anchored in the axial column 29 that is rigidly connected to the switch base, while the other end, 20, is connected to the switch housing or to the lever 18 in a positionally fixed location relative to the switching direction. Turning the switch housing or switching element 17 from the OFF position into the ON position slightly tensions the coil spring 19, i.e. a certain torque is produced which, however, is not strong enough to retract the switch housing back into the OFF position. But advancing it further into the Pulse On or Trigger position will generate a torque sufficiently strong to push the switch housing back into the ON position. This, of course, is helped by the fact that there is no detent in the Pulse On or Trigger position which would lock the switch housing in place relative to the switch base.

FIGS. 7a and 7b are cross-section views, rotated by 90° relative to each other, of the switch per FIGS. 1 and 2. The illustrations clearly show how the end 22 is anchored in the central, axial column 29. FIG. 7a, in particular, also shows that the central opening of the switch housing 17 additionally features an annular guide element 27 which ensures smooth rotatability of the switch housing 17 relative to the axial column 29 while at the same time serving as a backstop for the tensioning of the contact spring 15.

Clearly visible especially in FIG. 7b are the connecting points 11′ of the contact pins, designed to permit the connection of electrical circuitry.

Finally, the illustration clearly shows the cup spring 21 which serves not only to hold the switch assembly together but also to generate pressure as the switch housing 17 is turned, which pushes the switching element against the switch base 3, i.e. the cams 6—and 8 into the notches 4, 5 or 7 (not visible in FIGS. 7a and 7b). This ensures that the switch will click into the selected positions while preventing it from any self-actuated movement.

Of course, the electric switch illustrated in FIGS. 1 to 7 is only an example serving to more easily describe and explain the concept of this invention. It is entirely possible to configure the switch differently and to add other elements to it without departing from the invention. For example, additional switch positions may be incorporated, such as three fixed positions and one or several more Pulse On positions, etc. It is equally possible to use different materials for the manufacture of the various components. For example, the support body or switch base and the switch housing or switching element may be produced from a fiber-reinforced polymer such as POM (polyoxymethylene), polyamide, polypropylene etc. It will be necessary for the materials mentioned to offer good sliding properties to permit precise engagement of the cams 6 and 8 in the notches 4, 5 and 7. It is important for the polymer employed to have the necessary electrical properties as well as the required resistance to atmospheric, chemical and other conditions. Especially when installed in a hearing aid it is important that the polymer used be highly resistant to perspiration. The various contacts, including the contact elements, contact spring etc. must consist of a highly conductive material such as gold, copper and the like. A suitable material for producing the flat coil spring is stainless spring steel wire while for the cup spring a material such as nickel chromium steel is used. In general, however, one can use for all of these components whatever materials are suitable for their respective function.

1. Switch, with at least the OFF, ON and Pulse On or Trigger positions, said switch automatically springing back from the Pulse On or Trigger position into the ON position, characterized in that the minimum of three switch positions are arranged on an essentially circular support body or switch base (3) and that by means of a flat coil spring (19) the switching element or switch housing (17), rotatably supported on the switch base, can be pushed from the Pulse On or Trigger position into the ON position.

2. Switch, especially as in claim 1, characterized in that at least one essentially circular support body or switch base having contact sections (11) is provided with a switching element or switch housing capable of rotating around the central axis of the support body and of being pushed by the flat coil spring from the Pulse On or Trigger position into the ON position, said support body and switching element being connected to the coil spring via a central axial column (29) which on its part is rigidly connected to the support body, the assembly being resiliently held in place and together by means of a cup spring (21).

3. Switch, especially as in claim 1 or 2, characterized in that an array of detents (4, 5, 6, 7, 8) is provided between the support body and the switching element.

4. Switch, especially as in claim 3, characterized in that the detent array includes at least one detent each for the OFF and ON positions but preferably not, or less so, for the Pulse On or Trigger position.

5. Switch, especially as in one of the claims 1 to 4, characterized in that each three detents are provided for the OFF and ON positions, mutually offset i.e. spaced apart by about 120°.

6. Switch, especially as in one of the claims 1 to 5, characterized in that the switching element or switch housing which features a laterally extending actuating unit (18) such as a lever, is provided on its side facing the support body with a strip conductor (15) or contact area by means of which, when the actuating unit is operated, contact elements (11) mounted in the support body are electrically connected in the ON position or in the Pulse On or Trigger position.

7. Switch, especially as in one of the claims 1 to 6, characterized in that the coil spring is operationally connected to the actuating unit in such fashion that, when the switching element or switch housing is rotated at least from the ON position to the Pulse On or Trigger position, said spring is tensioned so as to push the switching element back into the ON position.

8. Electric or electronic component provided with an electric switch per one of the claims 1 to 7, characterized in that the Pulse On or Trigger position is employed for operating a menu control system i.e. for switching between different programs.

9. Hearing aid equipped with an electric switch per one of the claims 1 to 7.
